(19) United States
(12) Patent Application Publication
(10) Pub. No.: US 2017/0218203 A1
(43) Pub. Date: Aug. 3, 2017

(54) Yellow Colorant Composition Having Improved Chroma And Hue, Pigment Composition Therefor, And Use Thereof

(71) Applicant: CLARIANT INTERNATIONAL LTD., Muttenz (CH)

(72) Inventors: Daisuke Harada, Shimada City (JP); Ulrike ROHR, Weinheim (DE); Eusebio RUIZ FERNANDEZ, Frankfurt am Main (DE)

(73) Assignee: CLARIANT INTERNATIONAL LTD., Muttenz (CH)

(21) Appl. No.: 15/500,678

(22) PCT Filed: Jul. 28, 2015
(86) PCT No.: PCT/EP2015/067281

§ 371 Date: Jan. 31, 2017

(30) Foreign Application Priority Data
Aug. 1, 2014 (JP) 2014-157613

(51) Int. Cl. C09B 67/46; C09B 67/08; C09B 67/22

(52) U.S. Cl. CPC C09B 67/009; C09B 67/0055; C09B 67/0033; C09B 67/001

(57) ABSTRACT

Problem to be Solved

It is intended to provide a yellow colorant composition having improved chroma and lightness, a pigment composition therefor, and use thereof for forming images.

Solution

The present invention provides a colorant composition containing a yellow pigment, a yellow fluorescent dye, and a resin binder, wherein the maximum reflectance wavelength in the visible reflection spectrum of a coating film consisting of the fluorescent dye and the resin binder without comprising the yellow pigment falls within the range of 490 to 535 nm, and the maximum reflectance of the coating film is 90 to 140%.

The present invention relates to a yellow colorant composition improved in terms of chroma and hue by use of a fluorescent dye.

### BACKGROUND ART

Methods for forming or displaying images by the subtractive color process using printing inks, coating materials, toner, ink-jet inks, or the like are performed by the combination of three primary colors yellow (Y), magenta (M), and cyan (C). A colorant having high lightness (L in the LCH space), chroma (C), and hue (H) is necessary for each of these three primary colors, and organic pigments used therefor are required to have high performance.

Particularly, when images represented on a color display such as a liquid crystal display are printed on a color printer, the color reproduction range of the printer ink (YMC color space) is narrower than the color reproduction range on the color display (ROB color space) and, due to this, the images tend to be less sharp.

For example, when photographic images from a digital camera are observed on a liquid crystal display or the like and then a hard copy is printed on a color printer, the hard copy is inferior in sharpness, etc. to images on the liquid crystal display because the color reproducibility of the hard copy is lower than the color reproducibility of the display. A main cause of the low color reproducibility of the hard copy is, for example, low performance such as chroma of pigments for image formation.

For solving the problems mentioned above, yellow toner that is excellent in chroma and hue and has favorable light resistance has been required as, for example, yellow toner for laser printers. For example, use of mixed crystals consisting of al. Pigment Yellow 185 and al. Pigment Yellow 139 has been proposed as an approach thereto (Patent Document 1).

Furthermore, yellow pigments not only serve as representing three primary colors Y, M, and C but are often required to have the function of representing green hue by mixing with cyan. There are thus needs for enhancing the chrome of yellow pigments in order to enhance the chroma of the green color. In response to such needs, use of various yellow pigments such as al. Pigment Yellow 17 and C.I. Pigment Yellow 83 has been proposed for enhancing the chrome of electrophotographic green toner (Patent Document 2).

As for other demands for yellow pigments, there are wide-ranging needs for using them for yellow while imparting slight bluishness to their hue. Therefore, for example, the fine adjustment of hue by mixing different yellow pigments has been proposed (Patent Document 3).

As a result of many such attempts, yellow pigments having high chroma and also excellent in weather resistance, etc. have been developed, such as al. Pigment Yellow 180 as described in, for example, Patent Document 4. However, demands for higher image quality and color reproducibility require colorants to have higher performance.

The above description relates to, mainly, the attempts to improve pigments themselves or to improve colorants by combination thereof. A further means is also considered, which uses a system with a coloring fluorescent dye mixed as shown in Patent Document 5. According to this document, the chroma is improved by adding a fluorescent dye to a color pigment. However, mere addition of a coloring fluorescent dye by a general method may rather adversely affect color reproduction due to serious side effects such as change in hue caused thereby. For example, addition of a red fluorescent dye to a yellow pigment might enhance the chrome, but renders its hue reddish. The resulting pigment is thus difficult to use as a yellow pigment. Furthermore, even if the fluorescent dye is yellow, its fluorescence is too strong fluorescence and visual stimulation increases and might have an unfavorable influence thereon.

Although improvement in chroma may be expected by the addition of a fluorescent dye, as described above, serious side effects caused thereby are of concern. In spite of this, the above Document 5 does not specifically disclose with what characteristics and in what amount a fluorescent dye should be added in order to obtain the required hue and chroma without entailing serious side effects.

The present inventors have proposed, in a previous patent application by the present applicant, the addition of a yellow fluorescent dye to a cyan pigment as means for improving the chroma of the cyan pigment (Patent Document 6). It has been found therein that remarkable improvement in chroma and moderate change in hue are obtained by the addition of a yellow fluorescent dye. Meanwhile, since it has been found that a large hue difference occurs due to the different color temperatures of light sources, the inventors mentioned therein that, for obtaining the hue and chroma of interest under light sources differing in color temperature, it is required to precisely control the characteristics of the fluorescent dye, the amount of the fluorescent dye added, etc.

The contents of the application described above by the present applicant discuss the enhancement of the chroma of a cyan pigment. In light of the results thereof, improvement in the chroma of a colorant can be expected by the addition of a fluorescent dye to a yellow pigment. In this case as well, the occurrence of a hue difference between different color temperatures of light sources, etc. is similarly predicted for yellow pigments. However, Document 6 does not disclose conditions to be satisfied by yellow pigments and fluorescent dyes for obtaining a yellow colorant having improved chroma and lightness while being bluish. None of the other prior documents including Document 5 discloses such conditions.

As mentioned above, for conventional colorants containing a yellow pigment, there are strong demands for improvement in the chroma and the lightness thereof, the impartment of bluishness thereto, etc. However, a colorant that satisfies the needs described above has not yet been realized.

### LIST OF RELATED ART DOCUMENTS

### Patent Document

### [Patent Document 1] JP5471865B

### [Patent Document 2] JP2012215732A

### [Patent Document 3] JPH11199811A

### [Patent Document 4] JP2005017838A

### [Patent Document 5] JP2008231211A

### [Patent Document 6] Japanese Patent Application No. 2014-140392

### SUMMARY OF INVENTION

### Problem to be Solved by the Invention

An object of the present invention is to obtain a colorant composition with a yellow pigment, which can achieve one or more of the following effects:
1) having improved chroma and lightness;
2) having yellow hue rendered weakly bluish; and
3) bringing only a small feeling of strangeness by hue difference observed in environments differing in color light source.

### Means for Solving the Problems

The present inventors have conducted diligent studies to attain the object described above and consequently gained the following findings;
(1) Use of a yellow fluorescent dye can improve performance, i.e., the addition of a specific yellow fluorescent dye to a yellow pigment can largely improve the chroma,
(2) Particularly, use of a yellow fluorescent dye having a maximum reflectance wavelength of 490 to 535 nm in the reflection spectrum can increase the chroma and the lightness while minimizing change in hue angle.
(3) The maximum value of the reflection spectrum described above is preferably 90% or more and also preferably 140% or less. Reflection intensity less than 90% is less effective for improving the chrome. Reflection intensity exceeding 140% is not preferred because fluorescence is too strong so that the so-called feeling of glare is conspicuous.)
(4) The addition of the yellow fluorescent dye of the present invention very greatly improves the chroma. In spite of this, change in hue angle is unexpectedly as small as only a few degrees. This is very preferred for imparting bluishness to a conventional general-purpose, yellow pigment.
(5) Moreover, change in hue perceivable by human sight even under light sources largely differing in color temperature can be reduced to a level much smaller than expected by setting the composition of the dye and the pigment to within specific ranges. This is preferred for practical use.

Accordingly, the present invention relates to:
1. A colorant composition comprising a yellow pigment, a yellow fluorescent dye, and a resin binder, wherein the maximum reflectance wavelength in the visible reflection spectrum of a coating film consisting of the fluorescent dye and the resin binder without comprising the yellow pigment falls within the range of 490 to 535 nm, and the maximum reflectance of the coating film is 90 to 140%.
2. A colorant composition as set forth in the above 1, wherein the hue angle of the yellow pigment falls within the range of 90 to 99°.
3. A colorant composition as set forth in the above 1 or 2, wherein the yellow pigment comprises one or more pigments selected from C.I. Pigment Yellow 74, C.I. Pigment Yellow 120, C.I. Pigment Yellow 155, C.I. Pigment Yellow 180, and C.I. Pigment Yellow 185.
4. A colorant composition as set forth in any one of the above 1 to 3, wherein the absorption maximum wavelength of the yellow fluorescent dye falls within the range of 380 to 450 nm.
5. A colorant composition as set forth in any one of the above 1 to 4, wherein the hue angle of a coating film consisting of the yellow fluorescent dye and the resin binder on white paper is larger than the hue angle of a coating film consisting of the yellow pigment and the resin binder on white paper.
6. A colorant composition as set forth in any one of the above 1 to 5, wherein the yellow fluorescent dye comprises one or more dyes selected from a coumarin, a stilbene, and a naphthalimide.
7. A colorant composition as set forth in any one of the above 1 to 6, wherein the yellow fluorescent dye comprises one or more dyes selected from al. Solvent Yellow 33, al. Solvent Yellow 98, al. Solvent Yellow 131, al. Solvent Yellow 135, and al. Solvent Yellow 160:1.
8. A colorant composition as set forth in any one of the above 1 to 7, wherein the yellow fluorescent dye is present in an amount of 0.01 to 30 parts by mass relative to 100 parts by mass of the yellow pigment.
9. A colorant composition as set forth in any one of the above 1 to 8, wherein the resin binder comprises one or more resins selected from a polyester, a polystyrene derivative, an acrylic resin derivative, and a urethane resin.
10. A colorant composition as set forth in any one of the above 1 to 9, wherein when the colorant is applied onto white paper, the hue difference ΔE between the hue of the coating under the daylight color light source D65 (color temperature=6500° K) and the hue under the room light-type light source A10 (color temperature=3000° K) is 6.5 or less.
11. A pigment composition for use in preparing a colorant composition as set forth in any one of the above 1 to 10, wherein the pigment composition comprises 0.01 to 30 parts by mass of the yellow fluorescent dye relative to 100 parts by mass of the yellow pigment.
12. Use of a colorant composition as set forth in any one of the above 1 to 10 or a pigment composition as set forth in the above 11 for forming images.

### Advantageous Effects of Invention

According to the present invention, by the addition of a specific yellow fluorescent dye, a colorant composition containing a yellow pigment is obtainable, which can:
1) improve the chrome and the lightness,
2) impart bluishness to yellow hue; and
3) provide a small hue difference, which brings only a small feeling of strangeness when observed in environments differing in color light source.

Therefore, the colorant composition according to the present invention can not only be used in various image formation applications including printing inks, toner or developers, ink jet inks, and the like, but may be used in other applications such as coating materials.

### Mode for Carrying Out the Invention

That is, the present invention relates to a colorant composition comprising a yellow pigment and a specific yellow fluorescent dye and further comprising a binder.

The color pigment that can be used in the present invention is not particularly limited as long as it is a yellow pigment. For obtaining a colorant rendered slightly more bluish than the standard yellow (hue angle=90°), it is desirable that the hue angle of the yellow pigment should fall within the range of 85° to 100°. Particularly preferably, the hue angle is 90 to 99°. At a hue angle smaller than this range, the hue is rendered reddish or the chrome tends to be reduced. Alternatively, at a hue angle larger than this range, the bluishness or greenishness might become too strong.

The yellow pigment having the hue described above can be appropriately selected from monoazo pigments, disazo pigments, benzimidazolone pigments, bis-acetoacetallylide pigments, isoindoline pigments, quinophthalone pigments, quinoxalinedione pigments, and the like. Among them, the yellow pigment having a hue angle that fails within the range of 90 to 99° as mentioned above includes C.I. Pigment Yellow 74 (hue angle derived only from the pigment and the resin=93.9°), C.I. Pigment Yellow 120 (hue angle derived only from the pigment and the resin=94.5°), C.I. Pigment Yellow 155 (hue angle derived only from the pigment and the resin 96.5°), C.I. Pigment Yellow 180 (hue angle derived only from the pigment and the resin=93.5°), and C.I. Pigment Yellow 185 (hue angle derived only from the pigment and the resin 95.5°). Alternatively, C.I. Pigment Yellow 12, 13, 14, 17, 93, 128, 138, 139, 151, 154, 174, 194, 198, 213, 214, 217, or the like may be used.

The properties, such as particle size and surface area, of the yellow pigment of the present invention can be within the ranges described in prior documents, for example, Patent Document 1. The pigment can be used after being combined with a dispersing agent, a solvent, a resin, etc. and then dispersed under a high shearing force to a level suitable for intended applications. For example, the pigment is often dispersed until a particle size on the order of 100 nm to 1000 nm as measured using a laser-system particle size measurement apparatus and then used as a dispersion.

A dye having an absorption maximum wavelength that falls within the range of 380 to 450 nm in, for example, methyl ethyl ketone in an absorption spectrum measurement method mentioned later is preferred as the yellow fluorescent dye of the present invention. Since this wavelength range is close to the absorption wavelength region of a yellow pigment, the deviation of the hue of the colorant from yellow is small even by the addition of the yellow fluorescent dye. Furthermore, since the difference between the absorption wavelength and the fluorescence wavelength, i.e., the Stokes shift, is minimized, a fluorescent dye having large emission intensity is easily obtained.

A yellow fluorescent dye having an absorption maximum wavelength less than 380 nm may rarely produce large emission intensity, resulting in the difficulty in significantly improving the chroma. Alternatively, a fluorescent dye having an absorption maximum wavelength exceeding 450 nm is not much preferred for the colorant of the present invention because the hue starts to become reddish.

In this context, in reflection spectrum measurement (mentioned later), the above yellow fluorescent dye provides a maximum reflectance wavelength that falls within the range of 490 to 535 nm in the reflection spectrum of a coating film consisting of the dye and the resin used in the colorant composition of the present invention, and the maximum reflectance of the coating film is 90% or more. The maximum reflectance in the same wavelength region as above in the absence of the fluorescent dye is on the order of 85%. The difference between this reflectance and the reflectance 90% or more makes human sight perceive greenishness or bluishness.

It is preferred for the fluorescent dye according to the present invention that the maximum reflectance should be 140% or less. A maximum reflectance exceeding 140% is not preferred because the hue difference perceivable by human sight between different color temperatures of light sources, etc. is large.

In one preferred form of the yellow fluorescent dye used in the present invention, its hue angle is larger than the hue angle of the yellow pigment used. The hue angle of the yellow fluorescent dye is a hue angle measured in a mixing system of the dye and the resin excluding the yellow pigment in hue evaluation mentioned later. The hue angle of the pigment is similarly a hue angle measured in a mixing system of the pigment and the resin excluding the dye. Combination of the yellow pigment and the fluorescent dye that satisfy the conditions described above is preferred for obtaining a bluish yellow colorant composition. The difference in hue angle between the yellow pigment and the yellow fluorescent dye coexisting with each other is preferably 1 to 35°, particularly preferably 5 to 30°. This difference in hue angle smaller than the range described above is less effective for conferring bluishness. A difference larger than this range is not preferred because change in the hue of the colorant tends to be conspicuous when the colorant suffers from light deterioration or the like.

In the colorant composition of the present invention, when the yellow pigment of the present invention or the yellow fluorescent dye of the present invention are each present as a mixture of a plurality of types, the hue angle refers to the hue angle of the yellow pigment or the yellow fluorescent dye as such a mixing system.

The yellow fluorescent dye of the present invention can be appropriately selected from quinoline, coumarin, naphthalimide, perylene, fluorescein, benzothiazole, benzimidazole, benzoxazole, rubrene, and pyranine dyes, etc. Such dyes are mostly classified into fat-soluble dyes, disperse dyes, water-soluble dyes, etc.

According to one aspect of the present invention, the yellow fluorescent dye can be appropriately selected from fat-soluble dyes such as C.I. Solvent Yellow 33, al. Solvent Yellow 43, C.I. Solvent Yellow 44, C.I. Solvent Yellow 85, al. Solvent Yellow 98, C.I. Solvent Yellow 104, al. Solvent Yellow 116, C.I. Solvent Yellow 131, C.I. Solvent Yellow 135, al. Solvent Yellow 145, C.I. Solvent Yellow 160:1, C.I. Solvent Yellow 172, and al. Coumarin 6, disperse dyes such as al. Direct Yellow 81, and water-soluble dyes such as C.I. Basic Yellow 40. Among them, al. Solvent Yellow 33, C.I. Solvent Yellow 98, C.I. Solvent Yellow 135, or C.I. Solvent Yellow 160:1 is particularly preferred.

In the present invention, the yellow fluorescent dye is used in an amount of 0.01 to 30 parts by mass, particularly preferably 0.05 to 25 parts by mass, relative to 100 parts by mass of the yellow pigment. An amount smaller than this range is less effective for improving the chroma or lightness. Alternatively, when the amount is larger than this range, the deviation of the hue from the yellow region is large and the hue difference observed under conditions differing in light source color temperature is large.

The hue difference (ΔE) according to the present invention represents a difference in hue between two coated objects and is generally indicated by a spatial distance between them in the L*a*b* color space chart. This value is calculated according to ΔE=[(ΔL*)²+(Δa*)²+(Δb*)²]^{1/2}. In general, when ΔE is 2.0 or less, the different colors of the two objects allegedly become difficult to distinguish by human sight.

The hue difference (ΔE) for printed matter or the like is broadly classified into: hue difference when different samples are compared under a common light source; and hue difference when the same sample is observed under different color light sources. The former one corresponds to, for example, the case where printed matters printed at different days are compared under the same light source. In this case, the hue difference is more conspicuous because the difference is compared directly. ΔE exceeding 2 is allegedly required for human sight to recognize the difference under such conditions, and ΔE of 2 or less is allegedly difficult to distinguish by human sight. In the case of commercial printing such as offset printing, ΔE of 5 or less is regarded as a guide.

When the same sample is observed under different light sources, clear standards for the tolerance of the difference in hue between these light sources seem to be absent. This is probably because general printing inks for use in commercial printing or the like do not produce large hue difference even under different light sources. The present inventors have conducted the evaluation of change in hue caused by light sources mentioned later using reference ΔE of 6.5 or less as a preferred level or tolerable level.

The fluorescent dye according to the present invention is added in order to set the chroma, the lightness, or the hue to desirable values. It is preferred that, even when compared under different environments (e.g., the color temperature of the light source), the influence of these different environments on the coating film thus prepared should be small. In the present invention, a reflectance of the yellow fluorescent dye or a ratio between the yellow fluorescent dye and the yellow pigment exceeding the range described above is not preferred because the hue observed under, for example, the light source 065 (color temperature=6500° K) and the light source A10 (color temperature=3000° K) largely differs therebetween and gives observers the feeling of strangeness.

The colorant composition of the present invention requires a binder in addition to the yellow pigment and the yellow fluorescent dye. A binder that can disperse the pigment and the dye therein or can dissolve and retain the pigment and the dye therein is used. In the present, invention, various polymers are appropriately used according to intended applications. Any type of polymer such as thermoplastic, thermosetting, or radiation-curable polymer may be used as such a polymer. Resins including polyolefins such as polyethylene, rubber polymers obtained by the addition polymerization of butadiene or the like, polystyrenes, acrylic polymers obtained by the polymerization of methyl methacrylate or the like, polyesters obtained by the condensation of dihydric alcohols with dibasic carboxylic acids, and polyamides obtained by the condensation of secondary amines with dibasic carboxylic acids are preferably used as examples of the thermoplastic polymer.

Among them, a polyester, a styrene-acryl, a polyamide, or a polyurethane is particularly preferred in terms of solvent solubility, pigment dispersibility, physical/chemical stability, etc.

A resin three-dimensionally cross-linkable by light, heat, or the like, such as a polyfunctional acrylic acid monomer, an epoxy compound, or a phenol compound, is used as the thermosetting or radiation-curable resin of the present invention.

The ratio between the pigment and the resin in the colorant composition of the present invention largely differs depending on its intended applications and can be generally 0.5 to 30 parts by mass of, preferably 1 part by mass to 15 parts by mass of the pigment relative to 100 parts by mass of the resin. At a ratio less than this range, it is required to increase the film thickness for obtaining the necessary degree of coloring. This may reduce drying or fixation performance or may reduce image quality. A ratio exceeding the range described above is not preferred because the mechanical strength of pixels formed with the colorant composition, adhesion, etc. is reduced.

In addition to the yellow pigment, the yellow fluorescent dye and the binder, the colorant composition of the present invention may appropriately contain other materials in order to satisfy functions and physical properties necessary for its intended applications. Examples of such additives include pigment dispersants, UV absorbers for improvement in light resistance, surfactants for improvement in coating properties, tackifiers for improvement in adhesion to substrates, etc., and waxes for controlling the heat characteristics or surface characteristics of colored coatings. Also, in the case of toner or developers for printers, it is preferred to add a charge control agent for controlling the electrostatic characteristics. Furthermore, these additives can be added in amounts appropriate for each intended application.

As for the process for preparing the colorant composition of the present invention, various methods are possible according to the user's processing step or applications of the composition. For example, processes involving drying the yellow pigment, suitably crushing or pulverizing the pigment, and then, for example,
1) mixing the pigment with the fluorescent dye of the present invention, the resin, and a solvent and dissolving or dispersing the mixture by an appropriate method,
2) charging a mixture of the pigment and the fluorescent dye into a container and mixing and dispersing the mixture into the resin and a solvent at a different site, or
3) dissolving or dispersing in advance the pigment, the resin, a solvent, etc, and adding and dissolving a separately obtained dye alone,

can be appropriately used according to its intended applications or at the convenience of manufacturers or users.

However, the process for preparing the above colorant composition is not limited to the processes described above, and many processes can be used according to the intended application. In the case of, for example, electrophotographic toner, a process involving adding a monomer, an emulsifier, a polymerization initiator, and the like to a dispersion containing the yellow pigment and the yellow fluorescent dye and preparing the colorant composition by emulsion polymerization is also preferred.

Alternatively, the colorant composition may be prepared by dispersing the yellow pigment into the resin in the form of beads and adding the yellow fluorescent dye of the present invention to this dispersion system. It is required that the pigment, the dye, and the resin of the present invention should be contained in accordance with the condition specified by, particularly, claim 1, in the colorant composition film (pixels) formed on, for example, printing paper.

### EXAMPLES

Hereinafter, the present invention will be described with reference to Examples. However, the present invention is not intended to be limited by these examples.

### Example 1

The following colorant composition was prepared.

TABLE 1

| | | |
|---|---|---|
| Yellow | C.I. Pigment Yellow 180 | 0.6 parts by mass |
| pigment | (trade name: Toner Yellow HG, | |
| | manufactured by Clariant) | |
| Fluorescent | Solvent Yellow 160: 1 | 0.0006 parts by mass |
| dye | (LANXESS AG, Macrolex, | (0.1 part by mass |
| | Fluorescent Yellow 10GN) | relative to |
| | | 100 parts by mass |
| | | of the yellow pigment) |
| Polyester | Reichhold Chemicals, Inc., product | 10 parts by mass |
| resin | name: Finetone 382ES | |
| Solvent | Tetrahydrofuran | 20 parts by mass |

30 g of the composition described above was weighed and put into a 70-ml glass bottle. 70 g of glass beads having a diameter of 2 mm was weighed into the bottle and dispersed for 60 minutes using a vertical paint shaker to prepare pigment application sample (ink) A1. The ink thus prepared had a pigment concentration of 6%. This ink was developed onto coat paper (manufactured by Daio Paper Corp., trade name: Utrillo Coat, weighed amount: 157 g/m²) (actual value of whiteness measured with the spectrophotometer SPECTRO FLASH SF600: 86.05, hue in hue measurement mentioned later: L*=94.71, a*=1.24, and b*=0.77) using bar coater No. 2 and dried on a hot plate. The amount (wet) of a coating of the obtained application sample A1 was 12 μm. Furthermore, its yellow reflection density was 1.25 in a reflection density measurement apparatus (manufactured by Gretag-Macbeth Inc., SPECTOROEYE, gas filling-system tungsten lamp, illumination type A, no physical filter).

Here, the absorption maximum wavelength of the yellow fluorescent dye Solvent Yellow 160:1 was 420 nm.

### Example 2

Pigment application sample A2 was obtained in the same way as in Example 1 except that the ratio of the yellow fluorescent dye Solvent Yellow 160:1 was set to 0.5 parts by mass relative to 100 parts by mass of the yellow pigment (PY180). Its yellow reflection density was 1.30.

### Example 3

Pigment application sample A3 was obtained in the same way as in Example 1 except that the ratio of the yellow fluorescent dye Solvent Yellow 160:1 was set to 1 part by mass relative to 100 parts by mass of the yellow pigment (PY180). Its yellow reflection density was 1.34.

### Example 4

Pigment application sample A4 was obtained in the same way as in Example 1 except that the ratio of the yellow fluorescent dye Solvent Yellow 160:1 was set to 2 parts by mass relative to 100 parts by mass of the yellow pigment (PY180). Its yellow reflection density was 1.39.

### Example 5

Pigment application sample A5 was obtained in the same way as in Example 1 except that the ratio of the yellow fluorescent dye Solvent Yellow 160:1 was set to 5 parts by mass relative to 100 parts by mass of the yellow pigment (PY180). Its yellow reflection density was 1.46.

### Example 6

Pigment application sample A6 was obtained in the same way as in Example 1 except that the ratio of the yellow fluorescent dye Solvent Yellow 160:1 was set to 10 parts by mass relative to 100 parts by mass of the yellow pigment (PY180). Its yellow reflection density was 1.55.

### Example 7

Pigment application sample A7 was obtained in the same way as in Example 1 except that the ratio of the yellow fluorescent dye Solvent Yellow 160:1 was set to 20 parts by mass relative to 100 parts by mass of the yellow pigment (PY180). Its yellow reflection density was 1.62.

### Example 8

Pigment application sample A8 was obtained in the same way as in Example 6 except that the yellow pigment was changed to C.I. Pigment Yellow 155 (Toner Yellow 3GP manufactured by Clariant). Its yellow reflection density was 1.83.

### Example 9

Pigment application sample A9 was obtained in the same way as in Example 6 except that the yellow pigment was changed to C.I. Pigment Yellow 74 (Toner Yellow 5GXT manufactured by Clariant). Its yellow reflection density was 1.52.

### Example 10

Pigment application sample A16 was obtained in the same way as in Example 5 except that the yellow fluorescent dye Solvent Yellow 160:1 was changed to Solvent Yellow 98 (Hostasol Yellow 3G manufactured by Clariant). Its yellow reflection density was 1.47.

### Comparative Example 1

Comparative pigment application sample B1 containing no yellow fluorescent dye was obtained in the same way as in Example 1 except that the yellow fluorescent dye Solvent Yellow 160:1 was not added in Example 1.

### Comparative Example 2

Comparative pigment application sample 82 was obtained in the same way as in Example 1 except that 35 parts by mass of the yellow fluorescent dye Solvent Yellow 160:1 relative to 100 parts by mass of the yellow pigment were added in Example 1.

### Comparative Example 3

Comparative pigment application sample 83 containing no yellow fluorescent dye was obtained in the same way as in Example 8 except that the yellow fluorescent dye Solvent Yellow 160:1 was not added in Example 8 (Pigment Yellow 155).

### Comparative Example 4

Comparative pigment application sample B4 containing no yellow fluorescent dye was obtained in the same way as in Example 9 except that the yellow fluorescent dye Solvent Yellow 160:1 was not added in Example 9 (Pigment Yellow 74).

### Comparative Example 5

Comparative pigment application sample 85 was obtained in the same way as in Example 6 except that the non-fluorescent yellow dye Solvent Yellow 93 (Solvaperm yellow 2G manufactured by Clariant) was used instead of the yellow fluorescent dye Solvent Yellow 160:1 in Example 6.

### Comparative Example 6

Comparative pigment application sample 86 was obtained in the same way as in Example 8 except that the non-fluorescent yellow dye Solvent Yellow 93 (Solvaperm yellow 2G manufactured by Clariant) was used instead of the yellow fluorescent dye Solvent Yellow 160:1 in Example 8.

### Comparative Example 7

Comparative pigment application sample 87 was obtained in the same way as in Example 9 except that the non-fluorescent yellow dye Solvent Yellow 93 (Solvaperm yellow 20 manufactured by Clariant) was used instead of the yellow fluorescent dye Solvent Yellow 160:1 in Example 9.

(Evaluation of Pigment Application Sample)

The samples A1 to A10 according to the present invention and the comparative samples 81 to 87 thus obtained were evaluated for their properties described below by the following methods.

1) Hue evaluation
Color measurement was carried out at a viewing angle of 10° with D65 as a light source for measurement using a spectrophotometer [SPECTRA FLASH SF600 (manufactured by Data Color International)] to quantitatively evaluate lightness/chroma/hue (L*C*H*) or L*a*b*. In this context, the hue is based on the definition of the color system specified by CIE (International Commission on Illumination). Each sample for hue measurement was uniformly applied and dried under the conditions described above. The area of the sample was 7 cm². Furthermore, for each case, a composition excluding the dye or the pigment from each composition of Examples and Comparative Examples was used to prepare an application sample consisting of the pigment and the resin without containing the dye and an application sample consisting of the dye and the resin without containing the pigment. The hue angles of these samples were also measured by the same method as above. The results are shown in Table 2.

2) Evaluation of change in hue depending on light source
In the hue evaluation mentioned above, the measurements were carried out using both the standard daylight color light source (D65; color temperature 6500° K) and the room light-type light source A10 (color temperature 3000° K, and the hue difference (ΔE) between them was evaluated. In this context, the relationship between ΔE and sensory evaluation differs depending on the evaluation method thereof, but, in general, at hue differences of 2 or less, colors are reportedly difficult to distinguish by human sight. Furthermore, at ΔE within the range of more than 2.5 to 6.5 or less, colors are perceived as almost the same colors in general impression unless compared side-by-side. At ΔE within the range of more than 6.5 to 13.0 or less, colors differ by approximately 1, for example, in the Munsell color chart. ΔE less than 2.5 was judged as being favorable; ΔE of 2.5 to 6.5 was judged as being tolerable; and ΔE more than 6.5 was judged as being inadequate.

3) Measurement of visible reflectance and maximum reflection wavelength
A solution containing the resin, the yellow fluorescent dye, and the solvent mixed without containing the yellow pigment was applied and dried in the same way as mentioned above to prepare a reflection spectrum measurement sample. The measurement was carried out at a viewing angle of 10° with the light source D65 as a light source for measurement using a spectrophotometer [SPECTRA FLASH SF600 (manufactured by Data Color International)]. In this respect, standard white ceramic tiles (manufactured by Data Color International, manufacture lot serial #9197, average reflectance of visible light at 500 nm or more; 90% or more) attached to the spectrophotometer were used as the reference.
The obtained evaluation results are shown in Table 2.

The contents of Table 2 are summarized as follows,
1) The addition of 10 parts by mass of the yellow fluorescent dye Solvent Yellow 160:1 of the present invention relative to 100 parts by mass of Pigment Yellow 180 (Example 6) increases the chroma C by approximately 12. Furthermore, the hue angle H is changed by 3.8, and the lightness L is increased by 2.6.
2) The addition of 0.1 part by mass of the yellow fluorescent dye Solvent Yellow 160:1 of the present invention relative to 100 parts by mass of Pigment Yellow 180 (Example 1) was confirmed to have a chroma-improving effect such that the chroma C is increased by approximately 2.5. Furthermore, the hue angle H is changed by 0.01, and the lightness L is increased by 0.15.
3) As for the hue difference between different color light sources, the addition of approximately 20 parts by mass of the fluorescent dye causes ΔE to exceed 6 (Example 7), which is however a level that is generally not easy to recognize unless compared at the same site, and is considered sufficient for practical use.
4) An amount of the fluorescent dye added set to 35 parts by mass or more (Comparative Example 2) was considered to be unfavorable because decreasing tendency was found in the lightness and increase in the hue difference between different light sources was more than 6.5, though the chrome was high. The maximum reflectance wavelength in the visible reflection spectrum of a film consisting of the yellow fluorescent dye and the resin, excluding the yellow pigment from the composition of Comparative Example 2, was 536 nm. The reason why the hue difference in this Comparative Example 2 was a value as large as 6.78 was probably the shift of the reflection wavelength caused by the increase in the amount of the fluorescent dye added.
5) Furthermore, the addition of the non-fluorescent dye C.I. Solvent Yellow 93 was very low effective both for the chroma and for the lightness. Its advantage was concluded to be small in consideration of reduction in light resistance caused by the addition of the non-fluorescent dye.

TABLE 2

| | | | | Part by mass | | | | | | | |
|---|---|---|---|---|---|---|---|---|---|---|---|
| | | | | of Y dye | | | | | | Maximum | Maximum |
| | | Hue | | relative to | L* | | H | Change in hue | Hue | reflectance | reflectance |
| | | angle of | | 100 parts of | (light- | C* | (hue | caused by light | angle | of dye | wavelength of dye |
| Example | Pigment | pigment | Dye | pigment | ness) | (chroma) | angle) | source (ΔE) | of dye | (%) | (nm) |
| 1 | PY180 | 93.5 | SY160:1 | 0.1 | 88.96 | 80.31 | 93.51 | 0.56 Favorable | 120 | 106 | 496 |
| 2 | PY180 | 93.5 | SY160:1 | 0.5 | 89.23 | 93.37 | 93.54 | 1.23 Favorable | 119 | 117 | 500 |
| 3 | PY180 | 93.5 | SY160:1 | 1 | 89.38 | 87.36 | 93.56 | 1.97 Favorable | 117 | 121 | 506 |
| 4 | PY180 | 93.5 | SY160:1 | 2 | 89.87 | 89.54 | 94.29 | 3.54 Tolerable | 115 | 126 | 509 |
| 5 | PY180 | 93.5 | SY160:1 | 5 | 90.38 | 90.10 | 96.13 | 4.76 Tolerable | 112 | 124 | 514 |
| 6 | PY180 | 93.5 | SY160:1 | 10 | 91.44 | 90.23 | 97.34 | 5.81 Tolerable | 107 | 120 | 521 |
| 7 | PY180 | 93.5 | SY160:1 | 20 | 90.66 | 93.90 | 96.82 | 6.43 Tolerable | 106 | 115 | 524 |
| 8 | PY155 | 96.5 | SY160:1 | 10 | 91.91 | 89.90 | 98.84 | 1.66 Favorable | 107 | 120 | 521 |
| 9 | PY74 | 93.9 | SY160:1 | 10 | 91.66 | 90.45 | 97.43 | 3.51 Tolerable | 107 | 120 | 521 |
| 10 | PY180 | 93.5 | SY98 | 5 | 89.55 | 81.2 | 93.43 | 1.86 Favorable | 113 | 114 | 528 |
| 1 Comp. | PY180 | 93.5 | — | 0 | 88.81 | 77.86 | 93.50 | 0.01 Favorable | — | — | — |
| 2 Comp. | PY180 | 93.5 | SY160:1 | 35 | 90.26 | 95.84 | 95.82 | 6.78 Inadequate | 105 | 113 | 536 |
| 3 Comp. | PY155 | 96.5 | — | 0 | 89.76 | 76.18 | 96.51 | 0.01 Favorable | — | — | — |
| 4 Comp. | PY74 | 93.9 | — | 0 | 87.43 | 79.45 | 93.94 | 0.02 Favorable | — | — | — |
| 5 Comp. | PY180 | 93.5 | SY93 | 10 | 89.81 | 78.81 | 93.30 | 0.01 Favorable | 104 | 86 | 540 nm or more |
| 6 Comp. | PY155 | 96.5 | SY93 | 10 | 89.98 | 77.13 | 95.53 | 0.03 Favorable | 104 | 86 | 540 nm or more |
| 7 Comp. | PY74 | 93.9 | SY93 | 10 | 87.73 | 79.75 | 93.44 | 0.02 Favorable | 104 | 86 | 540 nm or more |

1. A colorant composition comprising a yellow pigment, a yellow fluorescent dye, and a resin binder, wherein the maximum reflectance wavelength in the visible reflection spectrum of a coating film consisting of the fluorescent dye and the resin binder without comprising the yellow pigment falls within the range of 490 to 535 nm, and the maximum reflectance of the coating film is 90 to 140%.

2. A colorant composition as claimed in claim 1, wherein the hue angle of the yellow pigment falls within the range of 90 to 99°.

3. A colorant composition as claimed in claim 1, wherein the yellow pigment comprises one or more pigments selected from the group consisting of C.I. Pigment Yellow 74, C.I. Pigment Yellow 120, C.I. Pigment Yellow 155, C.I. Pigment Yellow 180, and C.I. Pigment Yellow 185.

4. A colorant composition as claimed in claim 1, wherein the absorption maximum wavelength of the yellow fluorescent dye falls within the range of 380 to 450 nm.

5. A colorant composition as claimed in claim 1, wherein the hue angle of a coating film consisting of the yellow fluorescent dye and the resin binder on white paper is larger than the hue angle of a coating film consisting of the yellow pigment and the resin binder on white paper.

6. A colorant composition as claimed in claim 1, wherein the yellow fluorescent dye comprises one or more dyes selected from the group consisting of a coumarin, a stilbene, and a naphthalimide.

7. A colorant composition as claimed in claim 1, wherein the yellow fluorescent dye comprises one or more dyes selected from the group consisting of C.I. Solvent Yellow 33, C.I. Solvent Yellow 98, C.I. Solvent Yellow 131, C.I. Solvent Yellow 135, and C.I. Solvent Yellow 160:1.

8. A colorant composition as claimed in claim 1, wherein the yellow fluorescent dye is present in an amount of 0.01 to 30 parts by mass relative to 100 parts by mass of the yellow pigment.

9. A colorant composition as claimed in claim 1, wherein the resin binder comprises one or more resins selected from the group consisting of a polyester, a polystyrene derivative, an acrylic resin derivative, and a urethane resin.

10. A colorant composition as claimed in claim 1, wherein when the colorant is applied onto white paper, the hue difference ΔE between the hue of the coating under the daylight color light source D65 (color temperature=6500° K) and the hue under the room light-type light source A10 (color temperature=3000° K) is 6.5 or less.

11. A pigment composition comprising a colorant composition, wherein the colorant composition contains a yellow pigment, a yellow fluorescent dye, and a resin binder, wherein the maximum reflectance wavelength in the visible reflection spectrum of a coating film consisting of the fluorescent dye and the resin binder without comprising the yellow pigment falls within the range of 490 to 535 nm, and the maximum reflectance of the coating film is 90 to 140% and wherein the pigment composition comprises 0.01 to 30 parts by mass of the yellow fluorescent dye relative to 100 parts by mass of the yellow pigment.

12. A pigment composition as claimed in claim 11 for forming images.
